(19) United States
(12) Patent Application Publication
(10) Pub. No.: US 2024/0224140 A1
(43) Pub. Date: Jul. 4, 2024

(54) CARRIER SHUTDOWN FOR NODES IN A TELECOMMUNICATIONS NETWORK

(71) Applicant: HUAWEI TECHNOLOGIES CO., LTD., Shenzhen (CN)

(72) Inventors: David LOPEZ-PEREZ, Boulogne Billancourt (FR); Antonio DE DOMENICO, Boulogne Billancourt (FR); Nicola PIOVESAN, Boulogne Billancourt (FR); Hongqiang BAO, Shanghai (CN); Xinli GENG, Shanghai (CN)

(21) Appl. No.: 18/430,895

(22) Filed: Feb. 2, 2024

Related U.S. Application Data
(63) Continuation of application No. PCT/CN2021/110439, filed on Aug. 4, 2021.

(51) Int. Cl. H04W 36/00

(52) U.S. Cl. CPC H04W 36/0085

(57) ABSTRACT

The technology of this application relates to a first node in a telecommunications network configured to generate metric data for the first node and a set of nodes neighbouring the first node, wherein the metric data is derived based on measures of at least one of historical and current signal strengths received at a user equipment served by the first node, handover parameter information of the nodes neighbouring the first node, and historical handover information available at the first node. The technology of this application further provides generating, using the metric data, a set of target nodes from the set of nodes neighbouring the first node, wherein the set of target nodes include nodes for handover of the user equipment served by the first node in the event of deactivation of the first node.

### CROSS-REFERENCE TO RELATED APPLICATIONS

This application is a continuation of International Application No. PCT/CN2021/110439, filed on Aug. 4, 2021, the disclosure of which is hereby incorporated by reference in its entirety.

### TECHNICAL FIELD

The present disclosure relates, in general, to telecommunications networks. Aspects of the disclosure relate to carrier shutdown of nodes enabling energy saving.

### BACKGROUND

Cellular telecommunications networks are usually planned and deployed to meet certain requirements. As such, deployments that are predicated on the requirement to cope with traffic needs at peak hours typically lead to an over-dimensioning of the network for the less challenging traffic loads that are typically experienced at off-peak times, such as overnight for example. Despite the fact that 3rd Generation Partnership Project (3GPP) new radio (NR) deployments can provide an improved energy efficiency of around four times compared with 3GPP long term evolution (LTE) deployments due to their larger capacity and improved hardware, they can consume up to three times more energy than LTE ones, primarily due to the increased processing required to handle the wider bandwidth and the larger number of antennas that are demanded by such NR deployments.

However, as the traffic pattern experienced by a network deployment fluctuates over both time and space, underutilized resources can be dynamically turned off to save energy. For example, LTE and NR nodes, or base stations (BS), can implement energy saving schemes which allow a BS to dynamically switch off part of its hardware in order to reduce its power consumption. These energy saving features can be classified into three categories, depending on which hardware is shutdown:

Carrier shutdown, in which carriers are shut down within operator-specified periods. If, for example, a power amplifier (PA) of a radio frequency (RF) module serving a carrier that has been shut down is not serving any other operating carrier, the PA can also be shut down.

Channel shutdown, in which a BS can automatically shut down some transmit/receive multiple input multiple output (MIMO) channels during preset periods. In addition, such BSs can also automatically adjust a common channel transmit power of the cell to ensure its coverage and service continuity.

Symbol shutdown, which operates on an orthogonal frequency division multiplexing (OFDM) symbol level. Specifically, when a BS detects that a downlink symbol carries no data, it can shut down the PAs of RF modules in real time to reduce energy consumption. When the BS detects that a downlink symbol carries data, it can start the PAs in real time to ensure data transmission integrity.

Carrier shutdown plays a significant role in energy savings, particularly because of the low traffic at, e.g., night time and due to its ability to switch off a cell for longer periods of time. Generally speaking, however, such shutdown mechanisms are sub-optimal because of, amongst other things, the processes used to select nodes capable of participating in carrier shutdown and the constraints associated with relationships between nodes.

### SUMMARY

An objective of the present disclosure is to improve the performance of carrier shutdown procedures in telecommunications network deployments.

A first aspect of the present disclosure provides a first node in a telecommunications network, the first node configured to generate metric data for the first node and a set of nodes neighbouring the first node, the metric data derived based on measures of at least one of historical and current signal strengths received at a user equipment (UE) served by the first node, handover parameter information of the nodes neighbouring the first node, and historical handover information available at the first node, and generate, using the metric data, a set of target nodes from the set of nodes neighbouring the first node, the set of target nodes comprising nodes for handover of the UE served by the first node in the event of deactivation of the first node.

There is therefore provided a UE-centric carrier shutdown method in which nodes can establish a cooperation context between themselves in a decentralised and self-organising way. Any nodes can establish a cooperation context and a co-coverage neighbouring relationship rather than shutdown being predicated on the existence of coverage and basic cells. As such, there is also no requirement for manual basic cell identification, and relationships may be dynamically updated based on traffic load changes and/or when nodes switch off/on.

In an implementation of the first aspect, the first node can trigger determination of the measure of current signal strengths received at the user equipment served by the first node, and the handover parameter information of the nodes neighbouring the first node.

There is therefore no requirement for a cell-centric coverage overlap proportion metric. Rather, a UE-centric handover-based metric can be used to define co-coverage neighbouring relationships, thereby enabling UEs to be controllably offloaded to neighbouring nodes with which there is a cooperation context. This results in less stringent entry conditions since there is no need for all nodes with a cooperation context to meet the entry conditions. Accordingly, more carrier shutdown opportunities can be created when compared to current systems with consequent larger energy savings whilst ensuring user quality of service during and after carrier shutdown.

The first node can increment a counter representing a likelihood of handover of the UE served by the first node to a node of the set of target nodes. The counter can be incremented for the node of the set of target nodes that meets a set of received signal strength and handover entry conditions.

In an example, the first node can establish a cooperation context with a selected node from the set of target nodes. The first node can transmit a request for cooperation to the selected node, and generate a cooperation context on receipt of an acceptance to the request for cooperation from the selected node. The first node can determine whether the selected node is part of an existing cooperation context for the first node. The first node can remove a cooperation context with a selected node from the set of target nodes. The first node can determine whether the likelihood of handover of the UE served by the first node to selected node is below a predetermined threshold value.

A second aspect of the present disclosure provides an apparatus for energy saving in a first node of a telecommunications network, the apparatus being configured to generate metric data in relation to the first node and a set of nodes neighbouring the first node, the metric data derived based on measures of at least one of historical and current signal strengths received at a user equipment served by the first node, handover parameter information of the nodes neighbouring the first node, and historical handover information available at the first node, and generate, using the metric data, a set of target nodes from the set of nodes neighbouring the first node, the set of target nodes comprising nodes for handover of the UE served by the first node in the event of deactivation of the first node.

In an implementation of the second aspect, the apparatus can establish a cooperation context with one or more of the nodes of the set of target nodes. The apparatus can receive, from at least some nodes of the set of target nodes, information representing traffic requests from UE served by the at least some nodes. The apparatus can receive, from at least some nodes of the set of target nodes, information representing cell load for the at least some nodes. The apparatus can transmit, to one or more nodes of the set of target nodes, information representing at least one of information representing traffic requests from UE served by the first node and information representing cell load for the first node. The apparatus can wake up a node in the set of target nodes with which a cooperation context exists, and handover a UE from the first node to the node in the set of target nodes.

A third aspect of the present disclosure provides a method for establishing a cooperation context between a pair of neighbouring nodes in a telecommunication system, the method comprising transmitting a request from a first node of the pair of nodes to a second node of the pair of nodes to set up a cooperation context between the nodes to enable handover in the event of an energy saving carrier shutdown of one of the pair nodes.

In an implementation of the third aspect, the method can comprise receiving, at the first node, a confirmation message from the second node representing acceptance and confirmation of set up of the cooperation context between the nodes. The method can comprise receiving, at the first node, a decline message from the second node representing rejection of set up of the cooperation context between the nodes. The method can comprise receiving, at the first or second node, a removal message from the second or first node representing a request for removal of the cooperation context between the nodes. The method can further comprise receiving, at the first or second node, a request message for addition to the cooperation context.

A fourth aspect of the present disclosure provides a machine-readable storage medium encoded with instructions for establishing an enhanced co-coverage cooperation context between neighbouring nodes in a telecommunications network, the instructions executable by a processor of an apparatus of a first node, whereby to cause the apparatus to generate metric data in relation to the first node and a set of nodes neighbouring the first node, the metric data derived based on measures of at least one of historical and current signal strengths received at a user equipment served by the first node, handover parameter information of the nodes neighbouring the first node, and historical handover information available at the first node, and generate, using the metric data, a set of target nodes from the set of nodes neighbouring the first node, the set of target nodes comprising nodes for handover of the UE served by the first node in the event of deactivation of the first node.

These and other aspects of the technology will be apparent from the embodiment(s) described below.

### BRIEF DESCRIPTION OF THE DRAWINGS

In order that the present technology may be more readily understood, embodiments of the technology will now be described, by way of example, with reference to the accompanying drawings, in which:

FIG. 1 is a flowchart of a method for enhanced co-coverage neighbourhood learning according to an example embodiment;

FIG. 2 is a flowchart of a carrier shutdown process according to an example embodiment;

FIG. 3 is a flowchart of a carrier restart process according to an example embodiment;

FIG. 4 is a schematic representation of deployment of nodes in a telecommunications network according to an example embodiment;

FIG. 5 is a schematic representation of request and response messaging between nodes according to an example embodiment; and

FIG. 6 is a schematic representation of an apparatus according to an example embodiment.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

In its simplest form, a carrier shutdown process can utilize traffic prediction in which a network controller at a BS in question or a controller shared between multiple BSs compares a predicted load of a cell served by the node or nodes with a threshold value and determines, based on the comparison, which hours of the day the carrier shutdown feature should or could be activated. Multiple implementations of carrier shutdown exist, the three main types of which being intra-RAT (radio access technology) inter-frequency cell shutdown, LTE and NR intelligent carrier shutdown, and Multi-RAT carrier shutdown. The most complex of the implementations, being intra-RAT inter-frequency cell shutdown, shows a large degree of commonality with the other two implementations mentioned above.

In an intra-RAT inter-frequency cell shutdown implementation, two types of cells are defined: capacity cells, which are generally high-carrier frequency cells that can be shut down, and basic cells, which are manually identified low-carrier frequency cells that provide basic coverage, and which cannot be shut down. Generally, a capacity cell can only be shut down if a neighboring basic cell has been identified and paired with it. Neighboring relationships among capacity and basic cells can automatically be identified using the following procedure:
1. In capacity cells, the BS randomly selects UEs, and delivers measurement control messages to them instructing them to provide a measure of received signal power from all inter-frequency basic cells. This can leverage the 3GPP Self-Organizing Networks (SON) automatic neighboring relation (ANR) framework for example.
2. The BS receives the corresponding UE measurement reports (MR), and estimates the coverage overlap and the coverage hole proportions (where a coverage hole is a region in a cell where the received signal level of the potentially new serving cell below the levels required to maintain the service under a minimum level of quality and robust radio performance).
3. A basic cell with an overlapping coverage proportion with the capacity cell larger than a threshold is then considered as a co-coverage neighboring basic cell for the capacity cell.

When the carrier shutdown feature is activated, carrier shutdown entry conditions are used to determine whether a cell goes into carrier shutdown at a given point in time. As an example, a capacity cell can enter a co-coverage carrier shutdown state when the following conditions are met:
The intra-RAT inter-frequency cell shutdown feature is activated
The capacity cell has at least one neighboring basic cell
The capacity cell and all its identified co-coverage neighboring basic cells meet the following conditions:
   (uplink) UL load of local cell and UL load of a neighboring basic cell <UL physical resource block (PRB) usage threshold for the local cell to start shutdown
   (downlink) DL load of the local cell and DL load of a neighboring basic cell <DL PRB usage threshold for the local cell to start shutdown
   The number of UEs in a radio resource control (RRC) connected mode in the local cell is less than a predetermined threshold.

The proportion of coverage holes that may be caused by the shutdown of the capacity cell is less than a threshold.

After detecting that the shutdown entry conditions are met, the BS can directly block the capacity cell and notify its users and adjacent cells of its intention to shut down. If the number of UEs in an RRC connected mode in the capacity cell is larger than the threshold a given time after the shutdown procedure has started, the capacity cell aborts carrier shutdown and does not go to sleep. When a capacity cell is shut down, it can only be woken up by its basic cell. The basic cell wakes up the capacity cell when, for example, any of the following conditions are met:
The uplink PRB usage of the neighboring basic cell is higher than the uplink PRB threshold for exiting the carrier shutdown of the capacity cell
The downlink PRB usage of the neighboring basic cell is higher than the downlink PRB threshold for exiting the carrier shutdown of the capacity cell
The period specified for handover of UEs elapses
Neighboring basic cells are unavailable

Such a shutdown implementation suffers from several drawbacks. For example, basic cells need to be manually identified based on their frequency of operation, without considering the network layout or the network dynamics. Also, although co-coverage neighboring cell relationships can be learnt automatically, a capacity cell cannot be the basic cell of another capacity cell, which diminishes the carrier shutdown opportunities. It is also not possible to control handovers, i.e., to which cell each specific UE connected to a capacity cell is going to be handed over after the carrier shutdown, or load, i.e., whether the target cell will have enough capacity in light of the changing load, interference, and signal quality conditions after shutdown. As for a result, offloaded UEs after shutdown may handover to (or associate with) other cells that are different to the identified co-coverage neighboring basic cells. This is an issue as a capacity cell can only be switched on by its identified co-coverage neighboring basic cells and not by any other neighboring cell. It is also the case that all co-coverage neighboring basic cells of a capacity cell need to meet the entry conditions described above, even if no UE may eventually hand over to some of them. This is a problem when multiple basic cells per capacity cell are considered.

According to an example, there is provided a system, apparatus and method for creating an increased number of carrier shutdown opportunities compared with current implementations, with consequent larger energy savings, whilst ensuring user quality of service during and after carrier shutdown.

In an example, a co-coverage neighbouring cell set is defined, which allows a long-term cooperation context to be shared between any two cells in a network in a decentralized and self-organizing manner for the purposes of carrier shutdown. That is, cells in a telecommunications network can create co-coverage neighbouring relationships by establishing a cooperation context between themselves.

According to an example, enhanced co-coverage neighbouring cell learning is provided, which avoids the need for a manual basic cell identification, enables that not only basic cells but rather any two cells can establish a cooperation context and a co-coverage neighbouring relationship, and permits that such relationships can also be dynamically updated based on traffic load changes and/or when cells switch off/on.

Rather than using a cell-centric coverage overlap proportion metric, a user equipment (UE)-centric handover-based metric, which defines co-coverage neighbouring relationships, can be used. This means that UEs can be controllably offloaded to neighbouring cells with which there is a cooperation context. As a result, there are less stringent entry conditions as there is no need for all cells with a cooperation context to meet the entry conditions.

Thus, in order to drive carrier shutdown, a node in a telecommunications network can establish a cooperation context with neighbouring nodes. Each node in the network can, for example, implement a dynamic co-coverage neighbouring cell set, which is used to keep track and manage the cooperation context and the co-coverage relationships between nodes. The co-coverage neighbouring node set can comprise all neighbouring nodes to which its associated user equipment can be meaningfully handed over. Nodes that have a cooperation context with one another do not need to be basic cells as described above, which increases shutdown opportunities. Furthermore, a set of target nodes can be dynamically updated whenever the surrounding network topology or environment changes, again enabling an increase in shutdown opportunities. For each member of the set, related handover relationships and other information can be derived and stored as part of the set to aid carrier shutdown, thereby enabling better control of the offload process. In an example, a node (or some hardware of the node) will not be switched off if its co-coverage neighbouring set is empty, meaning that no neighbouring cell can take care of its associated UEs.

According to an example, a cooperation context between nodes can be established on the basis of a metric representing a handover relationship between pairs of nodes. For example, considering a source and target node pair, such a metric can be defined as a percentage of connected UEs of the source node that can be handed over to the target node. This metric may also comprise a number and/or likelihood of handover, the number and/or likelihood of cell or node (re)selections, and/or combinations of them.

In an example, the metric, comprising metric data, can be calculated using handover statistics among nodes, and/or RSRP (Reference Signal Receive Power) measurements determined from UE measurement reports together with intra/inter-frequency HO parameter configurations and/or node (re)selection parameter configurations. Both instantaneous and/or averaged versions of such metrics can be computed and stored in a co-coverage neighbouring set. For example, an instantaneous metric can help capture which co-coverage neighbouring node currently connected UEs will hand over to. An averaged metric can deal with new UEs that may appear or current ones that may move into areas for which there are no recent measurements, e.g., new coverage holes may appear. In an example, a node will not be turned off if the percentage of UEs (instantaneous and/or averaged) with no co-coverage neighbouring node to which they may be handed over is larger than a predefined threshold value.

According to an example, a HO-based metric can be derived from RSRP measurements from UE measurement as follows:

1. A BS of a cell, representing a first node in a telecommunications network, can instruct each of its connected UEs to take RSRP measurements over itself (e.g., the serving cell) and the neighbouring nodes, e.g., specified in a neighbouring cell list, and report back such RSRP information via a measurement report. As a result, the first node can acquire information from every connected UE that is served by the first node about how they perceive the neighbouring cells in terms of RSRP. The first node can use this information to build a statistical image of RSRP information by, e.g., averaging multiple measurement reports from the same UE and/or UEs over time.

2. Provided with such RSRP information and using the A3 HO event entry condition, which is used to trigger mobility procedures (other conditions may apply depending on the nature of the carrier frequencies of the cells), the first node can estimate to which neighbouring nodes its UEs are most likely to handover if the first node shuts down.

Note that the A3 HO event entry condition is presented here for the sake of illustration and that ‘Mn’ and ‘Mp’ (defined herein) are the RSRPs of the neighbouring and serving nodes, and that all the other offsets are managed and known by the first node. For each UE, the strongest neighbouring node will be the one selected as a target node for its handover, i.e., the one with the largest Mn+Ofn+Ocn+Hys according to the A3 HO event entry condition, which is specified as:

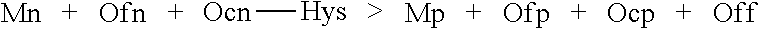

In which Mn is the measurement result of the neighbouring node, not taking into account any offsets, Ofn is the measurement object specific offset of the reference signal of the neighbour node (i.e., offsetMO as defined within measObjectNR corresponding to the neighbour node), Ocn is the specific offset of the neighbour node (i.e., cellIndividualOffset as defined within measObjectNR corresponding to the frequency of the neighbour node), and set to zero if not configured for the neighbour node, Mp is the measurement result of the PCell, not taking into account any offsets, Ofp is the measurement object specific offset of the primary cell (PCell, i.e., offsetMO as defined within measObjectNR corresponding to the PCell), Ocp is the cell specific offset of the PCell (i.e., cellIndividualOffset as defined within measObjectNR corresponding to the PCell), and is set to zero if not configured for the PCell, Hys is the hysteresis parameter for this event (i.e., hysteresis as defined within reportConfigNR for this event), Off is the offset parameter for this event (i.e., a3-Offset as defined within reportConfigNR for this event), where Mn, Mp are expressed in dBm in case of RSRP, or in dB in case of RSRQ and RS-SINR and Ofn, Ocn, Ofp, Ocp, Hys, and Off are expressed in dB.

In an example, using the estimates of all the UEs in the cell served by the first node over time, the first node can then compute metric data defining a HO-based metric and representing a percentage of connected UEs for the first node that will be handed over to each specific neighbouring cell. For each received measurement from a UE, the first node can compute the most likely target node and raise a counter for such a target node. The first node can also raise a counter every time a measurement report is received. The percentage (or metric) for each neighbouring node can then be calculated as the ratio of the former counter to the latter.

If the carrier shutdown feature for a node is not activated, each node can periodically updates its co-coverage neighbouring cell set and the related information using, as indicated earlier, HO statistics among cells, and/or using RSRP measurements from UE measurement reports together with the intra/inter-frequency HO parameter configurations and/or cell (re)selection parameter configurations. Collecting these statistics for long periods of time, even if the carrier shutdown feature is not activated, enables an improved statistical knowledge of the averaged metrics.

If the carrier shutdown feature is activated then, each node can update its co-coverage neighbouring cell set as indicated above. The frequency of the updates is, in an example, shorter now as the carrier shutdown feature is activated.

Each node may establish communication with (and address) any node in its co-coverage neighbouring set to stablish a long-term cooperation context for energy saving reasons. New co-coverage neighbouring set creation request messages can be used for this purpose. Each addressed node may accept or defer participation in the cooperation, depending on its capabilities. If cooperation is accepted, a cooperation context is created and stored. New co-coverage neighbouring cell set creation response messages can be used for this purpose, as described in more detail below. During cooperation, nodes can dynamically (de)activate co-coverage neighbouring relationships according to handover metrics and their traffic loads, for example, but the cooperation context can be maintained to enable fast additions/removals. New co-coverage neighbouring set addition/removal request/response messages can be used for this purpose. Nodes with an active cooperation context between them may share, periodically or on-demand, while cooperating, information about UE traffic requests and cell loads.

According to an example, a node with a large traffic load can wake up nodes a) with which it has active co-coverage neighbouring relationships, and that b) are currently in carrier shutdown.

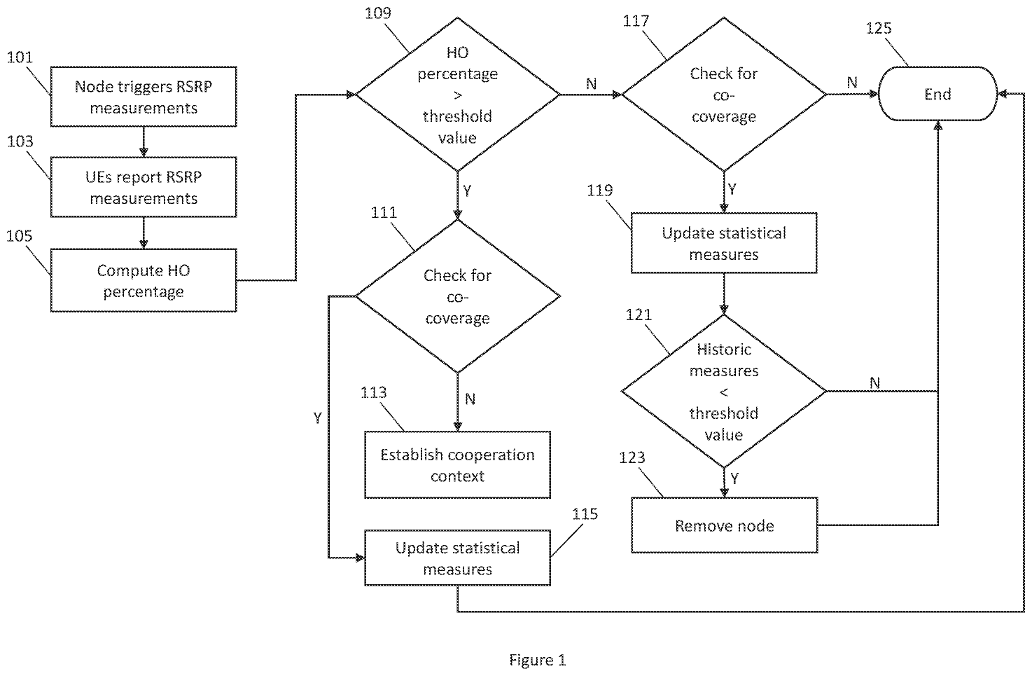

FIG. 1 is a flowchart of a method for enhanced co-coverage neighbourhood learning according to an example. In block 101 a first node, BSi, in a network deployment periodically (and independently) triggers RSRP measurements by UEs served in a cell (or cells) of the first node. For example, the first node can trigger its UEs to determine RSRP measurements representing the signal strength received by the UEs from each of a set of target nodes, BSj, (j∈J) neighbouring the first node. In block 103, the UEs perform and report the RSRP measurements to the first node. In block 105, the first node uses the reported RSRP measurements to calculate a measure,
HOPᵢⱼ, representing a percentage of UEs to be handed over to each neighbouring node if the first node deactivates, such as by shutting down to conserve power for example. In block 109, the value of HOPᵢⱼ is compared to a predefined threshold value to determine whether HOPᵢⱼ is greater than the threshold value. If it is, in block 111, for a given neighbouring node, a determination is made as to whether that neighbouring node is in the co-coverage neighbouring set of the first node—that is, whether the neighbouring node in question has a cooperation context established with the first node. If it does, in block 115, the instantaneous and/or historic statistical measures for the neighbouring node are updated according to the prevailing value of HOPᵢⱼ. The process then ends at block 125 or may return to block 101. If the neighbouring node in question does not have a cooperation context established with the first node then, in block 113, a cooperation context is established and the neighbouring node in question is added to a set representing nodes neighbouring the first node that have such a cooperation context with the first node. As will be described in more detail below, the cooperation context can be established using a request and response exchange between the first node and the neighbouring node under consideration.

Referring back to block 109, in the event that the value of HOPᵢⱼ is less than the threshold value then, in block 117, for the neighbouring node in question, a determination is made as to whether that neighbouring node is in the co-coverage neighbouring set of the first node. If it is not, the process ends at block 125 or may return to block 101. If, however, it is, in block 119, the instantaneous and/or historic statistical measures for the neighbouring node are updated with zero values (as opposed to the case in block 115 in which the values are updated in accordance with the prevailing value of HOPᵢⱼ). In block 121, it is determined whether the historical statistics for the neighbouring node in question are below a predefined minimum threshold value. If they are, in block 123, the neighbouring node is removed from the co-coverage neighbouring set as will be described in more detail below. Otherwise, the process ends at block 125 or may return to block 101.

Accordingly, metric data HOPᵢⱼ for the first node and a set of target nodes neighbouring the first node can be derived based on measures of at least one of historical and current signal strengths received at a user equipment served by the first node, handover parameter information of the nodes neighbouring the first node, and historical handover information available at the first node.

Node shutdown opportunities are amplified in view of the co-coverage neighbouring set and handover-based metric as described above. According to an example, a node can enters a carrier shutdown procedure when the instantaneous and average handover metrics are larger than predefined thresholds, meaning that all or an important number of the connected (or to be connected) UEs of a node can connect to another one node, and the required capacity is met in the co-coverage neighbouring node of the co-coverage neighbouring set to which such UEs will be handed over.

As part of the entry metric and procedure, the potential SINR (Signal to Interference and Noise Ratio) of the UE in the new serving node can be estimated, e.g., SSB-SINR (Synchronization Signal/PBCH block)/(channel state information reference signal) CSI-RS SINR. From this, it is possible to determine the PRB load of a UE under the new serving node and to check if appropriate capacity is available under the target node. Due to the decentralized nature of the process, and to avoid that multiple neighbouring capacity cells shutting down at the same time, a token-based protocol or a token at random could be used.

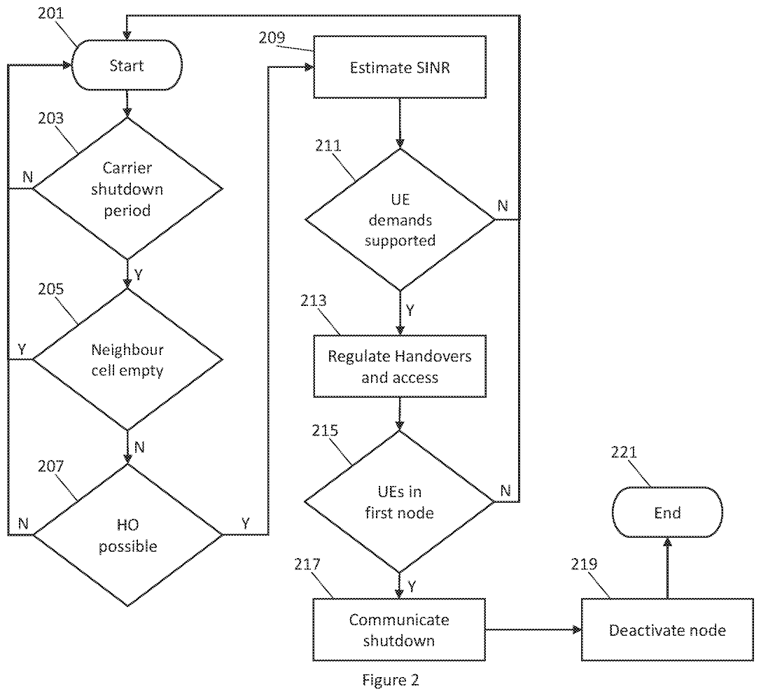

FIG. 2 is a flowchart of a carrier shutdown process according to an example. In block 201 the process starts and at block 203 it is determined whether the first node, which for the purposes of the description with respect to FIG. 2 is the node that is under consideration for shut down, is within a carrier shutdown period in which is available for shutdown. It may also be determined whether the first node is in possession of a shutdown token, or similar, which enables it to shut down if possible and is provided in order to prevent collisions in which multiple nodes attempt to shut down. If the first node is not within a shutdown period and/or if does not have a shutdown token, the process reverts to block 201 or ends. If the first node is within a shutdown period, it checks whether its co-coverage neighbouring cell set is empty. If it is, then there are no neighbouring cells where it can transfer its UEs and thus the carrier shutdown process it is aborted. The process reverts to block 201 or ends. Otherwise, in block 207, it is determined whether all UEs served by the first node can be handed over to the neighbouring nodes. If not, the process reverts to block 201 or ends. Otherwise, in block 209, the SINR of UEs to be handed over from the first node to the neighbouring node is estimated. That is, the SINR of UEs as it would be if the UEs were being served by the neighbouring node is estimated. In block 211, using the estimated SINR from block 209, it is determined whether the demands of UEs to be handed over from the first node can be supported or met in the target node, i.e., the neighbouring node. If not, the process reverts to block 201 or ends. Otherwise, in block 213, the first node forbids UE access and/or handover and hands over its UEs to the neighbouring node. In block 215, it is determined whether there are any UEs being served by the first node. If there are, the process reverts to block 201 or ends. Otherwise, in block 217, the first node communicates to nodes in the set of target nodes neighbouring the first node its intention to shut down. Nodes in the set of target nodes neighbouring the first node can record this intention, e.g., as part of the cooperation context. In block 219, the first node (or some hardware thereof) is shut down or deactivated. The process ends at block 221.

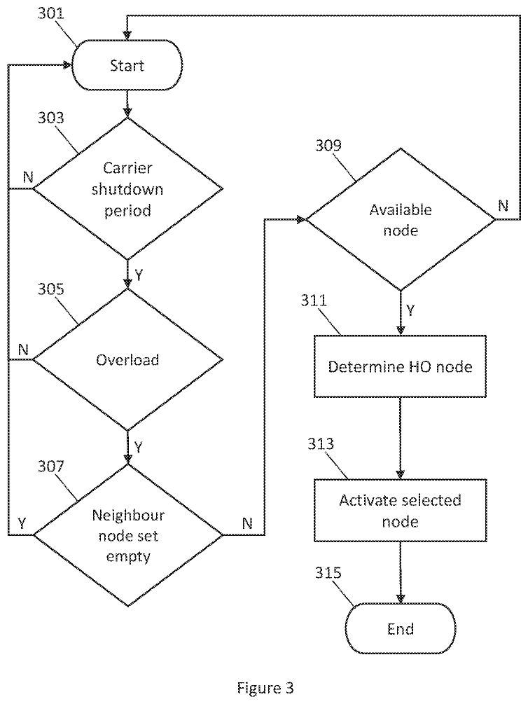

FIG. 3 is a flowchart of a carrier restart process according to an example. In block 301 the process starts. For the purposes of the description with respect to FIG. 3, the node under consideration is a node that is overloaded. In block 303 it is determined whether the node is within a carrier shutdown period. If not, the process reverts to block 301 or ends. Otherwise, in block 305, it is determined whether the node is overloaded. For example, whether the node is unable to adequately serve its UEs according to one or more quality of service metrics. If not, the process reverts to block 301 or ends. Otherwise, in block 307, it is determined whether the nodes from the set of target nodes neighbouring the first node is empty. That is, it is determined whether there are any nodes that UEs could be handed over to. If there are no such nodes, i.e., the set is empty, the process reverts to block 301 or ends. Otherwise, in block 309, it is determined whether there is a node in the set of target nodes neighbouring the first node that is deactivated. If not, the process reverts to block 301 or ends. Otherwise, in block 311, it is determined which node from the set of target nodes neighbouring the first node can be used to offload UEs of the first node. For example, it can be determined which node can be used to offload a number of UEs that results in the first node then being able to meet quality of service demands for remaining UEs following handover. In block 313, the node determined in block 311 is activated. UEs from the first (i.e., overloaded) node may then be offloaded to the activated node. The process ends at block 315.

Referring to FIG. 1 to 3, a first node can therefore instruct its UEs (i.e., UEs that is it serving) to take and report RSRP measurements. It can then use this metric data to establish a cooperation context with neighbouring nodes that enables it to activate nodes as required and/or handover UEs in the event that it is overloaded.

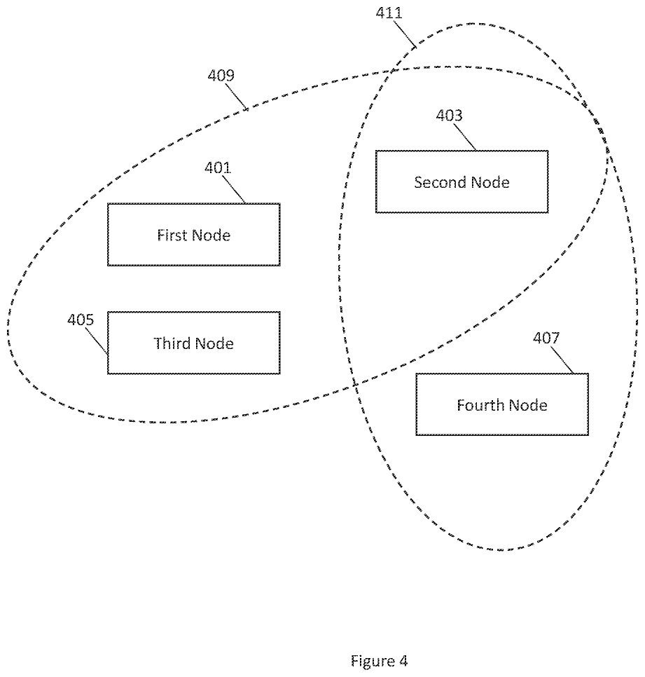

FIG. 4 is a schematic representation of deployment of nodes in a telecommunications network according to an example. In the example of FIG. 4, the first node 401 can execute the process described with reference to FIG. 1 and may determine that the third node 405 and second node 403 should be in its co-coverage neighbouring set and that a cooperation context among them is established. In current systems, a co-coverage neighbouring relationship would not be established between the first node 401 and the second node 403 as the latter is not a basic cell.

At some subsequent point in time after a cooperation context has been established as described above with reference to FIG. 1 for example, and while executing the process as described with reference to FIG. 2, first node 401 measures that it can hand 80% of its UEs over to third node 405 and the other 20% over to second node 403, and that its UEs will have the required quality of service with the respective nodes after its carrier shutdown. This can be estimated via the SINR and PRB estimation procedures as described above for example. First node 401 can then hand over its UEs to the respective nodes, and shuts down, first making the necessary checks as described above.

At some subsequent point in time after handover and shut down, and while executing the process as described with reference to FIG. 3, second node 403 may find that its capacity demands have significantly grown, and that it cannot cope with them. Then, and also executing the process as described with reference to FIG. 3, second node 403 can check its co-coverage neighbouring set, and find that it can wake or activate first node 401 to assist it, as they have a cooperation context stablished, and first node 401 is in shutdown. Note that current systems would not be able to wake up first node 401, as there would be no co-coverage neighbouring relationship among second node 403 and first node 401. Finally, second node 403 wakes up first node 401, and UEs handover to it.

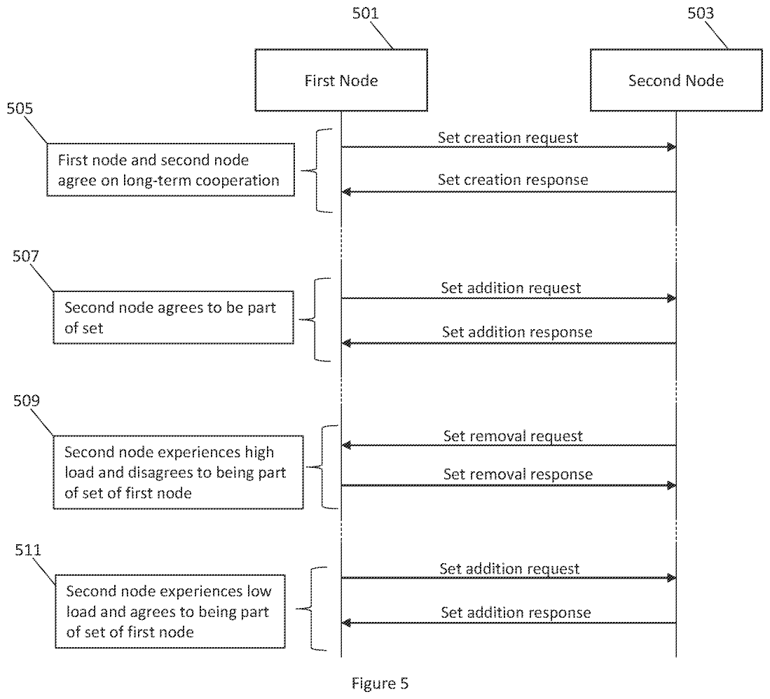

FIG. 5 is a schematic representation of request and response messaging between nodes according to an example. In the example of FIG. 5 four message exchanges, 503, 507, 509 and 511 are depicted between a first node 501 and a second node 503. The first node 501 and the second node 503 may have a cooperation context established between them and/or the second node may be part of a set of nodes neighbouring the first node 501 for example. The message exchanges depicted in FIG. 5 can be used to implement a method for establishing a cooperation context between a pair of neighbouring nodes in a telecommunication system for example.

In the message exchange 503, the first node 501 transmits a set creation request to the second node 503, which responds with a set creation response message. In this case, the first node 501 and the second node 503 agree on long-term cooperation as described above. That is, in relation to a pair of nodes comprising the first node 501 and the second node 503, the first node 501 can transmit a request to the second node 503 to set up a cooperation context between the nodes for the purposes of handover in the event of an energy saving carrier shutdown of one of the pair nodes. The first node can receive a confirmation message from the second node representing acceptance and confirmation of set up of the cooperation context between the nodes.

In the message exchange 505, the first node 501 transmits a set addition request to the second node 503, which responds with a set addition response message. In this case, the second node 503 agrees to be part of the set of target nodes of the first node 501 as described above.

In the message exchange 507, the second node 503 transmits a set removal request to the first node 501, which responds with a set removal response message. In this case, the second node 503 is experiencing, e.g., high load and disagrees on being part of the set of target nodes of the first node 501. Accordingly, the first node can receive a decline message from the second node representing rejection of set up of the cooperation context between the nodes.

In the message exchange 509, the first node 501 transmits a set addition request to the second node 503, which responds with a set addition response message. In this case, the second node 503 is experiencing, e.g., low load and agrees on being part of the set of target nodes of the first node 501.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a general-purpose computer, user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus (for example, a module implementing a function to trigger measurement of signal strengths, compute handover percentages, compare metric data against threshold values and update statistical measurements etc.) may be implemented by a processor executing machine readable instructions stored in a memory, or a processor operating in accordance with instructions embedded in logic circuitry. The term ‘processor’ is to be interpreted broadly to include a central processing unit (CPU), processing unit, application-specific integrated circuit (ASIC), logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

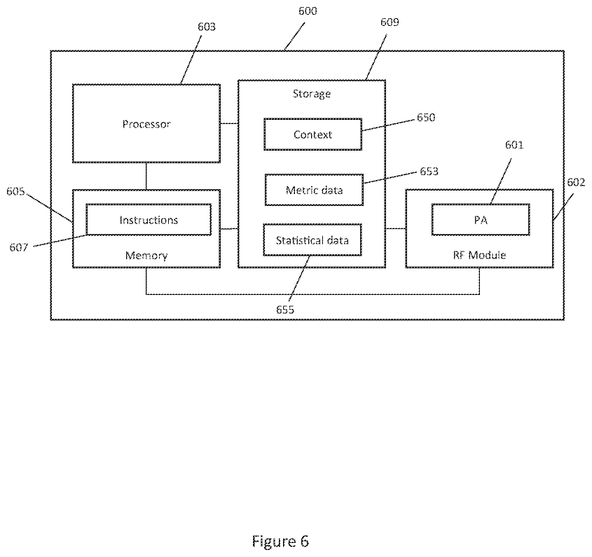

FIG. 6 is a schematic representation of an apparatus according to an example. The apparatus 600 can comprise, e.g., a node comprising a power amplifier 601 of an RF module 602. In another example, the apparatus 600 without, e.g., the power amplifier 601 of an RF module 602 can comprise apparatus suitable for installation for or within a node in a network deployment and which can enable control of shutdown or deactivation of that node.

The node or apparatus 600 comprises a processor 603, and a memory 605 to store instructions 607, executable by the processor 603. The machine comprises a storage 609 that can be used to store a cooperation context 650, metric data 653 and statistical values 655 for example. The instructions 607, executable by the processor 603, can cause the node 600 to generate metric data in relation to the first node and a set of nodes neighbouring the first node, the metric data derived based on measures of at least one of historical and current signal strengths received at a user equipment, UE, served by the first node, handover parameter information of the nodes neighbouring the first node, and historical handover information available at the first node, and generate, using the metric data, a set of target nodes from the set of nodes neighbouring the first node, the set of target nodes comprising nodes for handover of the UE served by the first node in the event of deactivation of the first node.

Accordingly, the node or apparatus 600 can implement a method for shut down or deactivation of a node in a telecommunications network.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment 300 for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. A first node in a telecommunications network, the first node comprising:
a processor; and
a memory configured to store computer readable instructions that, when executed by the processor, cause the first node to:
generate metric data for the first node and a set of nodes neighbouring the first node, wherein the metric data is derived based on measures of at least one of historical and current signal strengths received at a user equipment (UE) served by the first node, handover parameter information of the set of nodes neighbouring the first node, and historical handover information available at the first node; and
generate, using the metric data, a set of target nodes from the set of nodes neighbouring the first node, wherein the set of target nodes include nodes for handover of the UE served by the first node in the event of deactivation of the first node.

2. The first node of claim 1, wherein the first node is further caused to trigger determination of the measure of the current signal strengths received at the UE served by the first node, and the handover parameter information of the set of nodes neighbouring the first node.

3. The first node of claim 1, wherein the first node is further caused to:
increment a counter representing a likelihood of handover of the UE served by the first node to a node in the set of target nodes.

4. The first node of claim 3, wherein the counter is incremented for the node, in the set of target nodes, meeting a set of received signal strength and handover entry conditions.

5. The first node of claim 1, wherein the first node is further caused to establish a cooperation context with a selected node from the set of target nodes.

6. The first node of claim 5, wherein the first node is further caused to:
transmit a request for cooperation to the selected node; and
generate the cooperation context on receipt of an acceptance to the request for cooperation from the selected node.

7. The first node of claim 5, wherein the first node is further caused to:
determine whether the selected node is part of an existing cooperation context for the first node.

8. The first node of claim 5, wherein the first node is further caused to:
remove the cooperation context with the selected node from the set of target nodes.

9. The first node of claim 8, wherein the first node is further caused to:
determine whether a likelihood of handover of the UE served by the first node to the selected node is below a threshold value.

10. An apparatus for energy saving in a first node of a telecommunications network, the apparatus comprising:
a processor; and
a memory configured to store computer readable instructions that, when executed by the processor, cause the apparatus to:
generate metric data in relation to the first node and a set of nodes neighbouring the first node, wherein the metric data is derived based on measures of at least one of historical and current signal strengths received at a user equipment (UE) served by the first node, handover parameter information of the set of nodes neighbouring the first node, and historical handover information available at the first node; and
generate, using the metric data, a set of target nodes from the set of nodes neighbouring the first node, wherein the set of target nodes include nodes for handover of the UE served by the first node in the event of deactivation of the first node.

11. The apparatus of claim 10, wherein the apparatus is further caused to:
establish a cooperation context with one or more nodes in the set of target nodes.

12. The apparatus of claim 10, wherein the apparatus is further caused to:
receive, from at least some nodes in the set of target nodes, information representing traffic requests from the UE served by the at least some nodes.

13. The apparatus of claim 10, wherein the apparatus is further caused to:
receive, from at least some nodes in the set of target nodes, information representing cell load for the at least some nodes.

14. The apparatus of claim 10, wherein the apparatus is further caused to:
transmit, to one or more nodes in the set of target nodes, information representing at least one of information representing traffic requests from the UE served by the first node and information representing cell load for the first node.

15. The apparatus of claim 11, wherein the apparatus is further caused to:
wake up a node, in the set of target nodes, in which a cooperation context exists; and
handover a UE from the first node to the node in the set of target nodes.

16. A method for establishing a cooperation context between a pair of neighbouring nodes in a telecommunication system, the method comprising:
transmitting a request from a first node, in the pair of neighbouring nodes, to a second node, in the pair of neighbouring nodes, for setting up a cooperation context between the first and second nodes and enabling handover in an event of an energy saving carrier shutdown of one of the first and second nodes.

17. The method of claim 16, further comprising:
receiving, at the first node, a confirmation message from the second node representing acceptance and confirmation of setting up the cooperation context between the first and second nodes.

18. The method of claim 17, further comprising:
receiving, at the first node, a decline message from the second node representing rejection of setting up the cooperation context between the first and second nodes.

19. The method of claim 17, further comprising:
receiving, at the first or second node, a removal message from the first or second node representing a request for removal of the cooperation context between the first and second nodes.

20. A machine-readable storage medium encoded with instructions for establishing an enhanced co-coverage cooperation context between neighbouring nodes in a telecommunications network, the instructions, when executed by a processor of an apparatus of a first node, cause the apparatus to provide execution comprising:
generating metric data in relation to the first node and a set of nodes neighbouring the first node, wherein the metric data is derived based on measures of at least one of historical and current signal strengths received at a user equipment (UE) served by the first node, handover parameter information of the set of nodes neighbouring the first node, and historical handover information available at the first node; and
generating, using the metric data, a set of target nodes from the set of nodes neighbouring the first node, wherein the set of target nodes include nodes for handover of the UE served by the first node in the event of deactivation of the first node.
